(19) United States
(12) Patent Application Publication
(10) Pub. No.: US 2006/0113342 A1
(43) Pub. Date: Jun. 1, 2006

(54) Portable DVD holder

(76) Inventors: Poki Hampton, Covington, LA (US); Jan Hubbard, Mandeville, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 10/894,583

(22) Filed: Jul. 20, 2004

(51) Int. Cl. B60R 7/00

(52) U.S. Cl. 224/409; 224/42.33; 224/572; 224/901.8

(57) ABSTRACT

A holder for portable electronic device, such as a DVD player has a base with downwardly extending transverse flange. One or more slots are formed in opposing sides of the flange, and one or more flexible belts are extended through the slots. The belts have sufficient length to extend below a surface of a supporting panel, for instance a tray of an infant stroller. Strips of hook-and-loop fasteners are positioned on the top surface of the base to matchingly engage similar strips of fasteners securable on the bottom of the DVD player.

### BACKGROUND OF THE INVENTION

This invention relates to holders for electronic equipment, and more particularly to a portable DVD holder for use with a supporting structure, for instance a tray of an infant's stroller.

It is widely recognized that early visual stimulation of children plays an important role in child development. Various educational aids and stimulating toys have been developed for infants aged 3 months and older. Children can play or be entertained by mobiles suspended from the rails of baby cribs, by educational toys secured to a blanket or positioned inside a baby crib.

As children grow older, they begin to recognize moving images on television or video displays and are attracted to these images. A multitude of children entertainment programs have been developed for children of very young ages, teaching them colors, numbers, as well as abstract concepts. The educational programs are translated through television channels and can be enjoyed indoors. However, conventional television sets are impractical for use outdoors or as portable devices. Portable television sets are bulky and cumbersome and require a portable power source.

Some of the earlier technical solutions suggested incorporating an electronic device into a child carrier. For instance, U.S. Application No. 2003/0184032 A1, published on Oct. 2, 2003 discloses a shopping cart provided with an electronic device for entertaining children seated in the seat of the cart. One of the electronic devices may be a two-headphone jack connected to a radio receiver. The radio receiver is adapted for tuning to the frequency of the store's internal broadcast or to any desired frequency to allow the child to listen to music, stories, and other entertainment while the parent is shopping. In another embodiment of the cart, the electronic device is a television monitor that receives a signal from within the store. The store entertainment system may transmit cartoons, stories or educational programs that are of interest to young children directly to the electronic device.

While this technical solution may work with shopping carts and other strollers, the fact that the video program is limited to the in-store selected program may not be particularly attractive to all parents alike. Some parents may prefer that their children's entertainment and education come from a carefully selected list, which contains parent-approved program. This program may be written on a DVD disc and available to the public through regular commercial channels.

Another disadvantage of such type of a built-in system is that a parent cannot use the selected program while walking with a child seated in a stroller or while travelling.

The present invention contemplates provision of a holder for a portable DVD player that can be secured on a number of supporting structure, for instance a tray of a conventional stroller for viewing by a child seated or lying in the stroller.

### SUMMARY OF THE INVENTION

It is, therefore, an object of the present invention to provide a holder for an electronic entertainment device that can be detachably secured on a supporting structure, such as a tray of a stroller.

It is another object of the present invention to provide a holder for a portable electronic device that is easy to use and inexpensive to manufacture.

These and other objects of the invention are achieved through a provision of a holder, which comprises a base formed as a flat plate. A transverse unitary flange extends about the periphery of the plate; an upper portion of the flange forms a peripheral lip, while the downwardly extending portion of the flange is provided with opposing pairs of slots. One or more flexible belts are extended through the opposing slots; each belt has sufficient length to extend below the surface of the holder and form a loop, which can be tightened under the bottom of a supporting structure, for instance a tray of an infant stroller.

One or more strips of fasteners are secured on the top surface of the base plate. Matching strips of fasteners are securable on the bottom of the supporting structure. The fasteners may be hook-and-loop fasteners. The user places the holder on the supporting structure and loops the belts under the supporting structure. The belts may be tightened using corresponding buckles. The portable electronic device, for instance a DVD player, is placed on the base, while the fastener strips are aligned. The supporting structure may be a tray of an infant high chair, a bed tray, or other similar structure.

### BRIEF DESCRIPTION OF THE DRAWINGS

Reference will now be made to the drawings, wherein like parts are designated by like numerals and wherein FIG. 1 is a perspective view of the holder of the present invention secured to a tray of a stroller and supporting a portable DVD player.

FIG. 2 is a perspective view illustrating the holder of the present invention supporting a portable DVD player on a supporting structure.

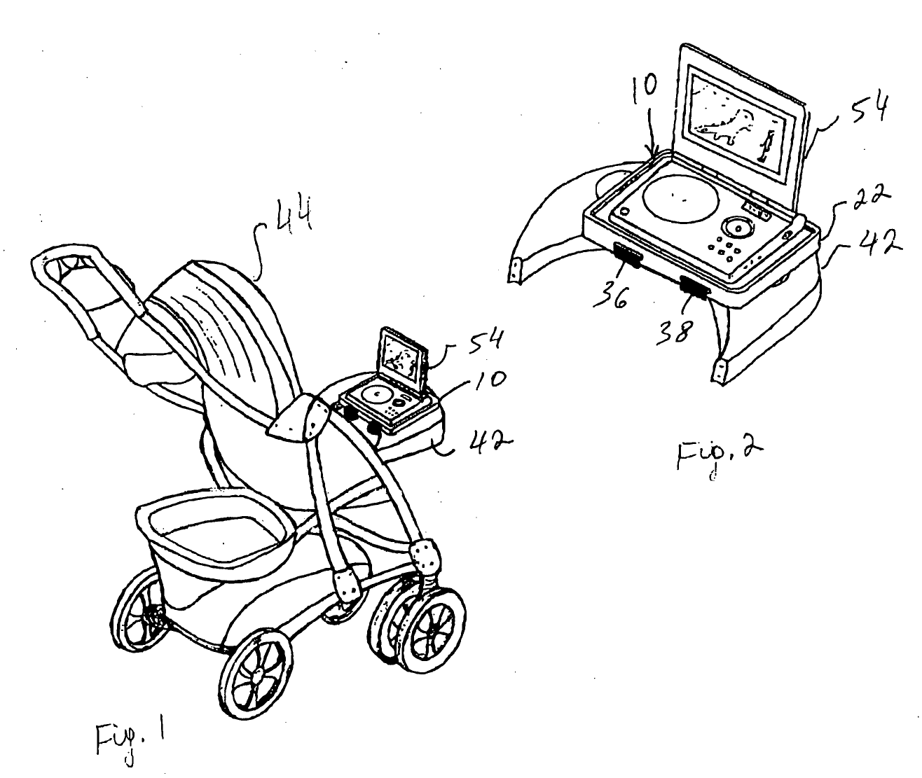

FIG. 3 is a perspective view of the holder of the present invention, with an exploded view of the position of a portable DVD player and a supporting structure.

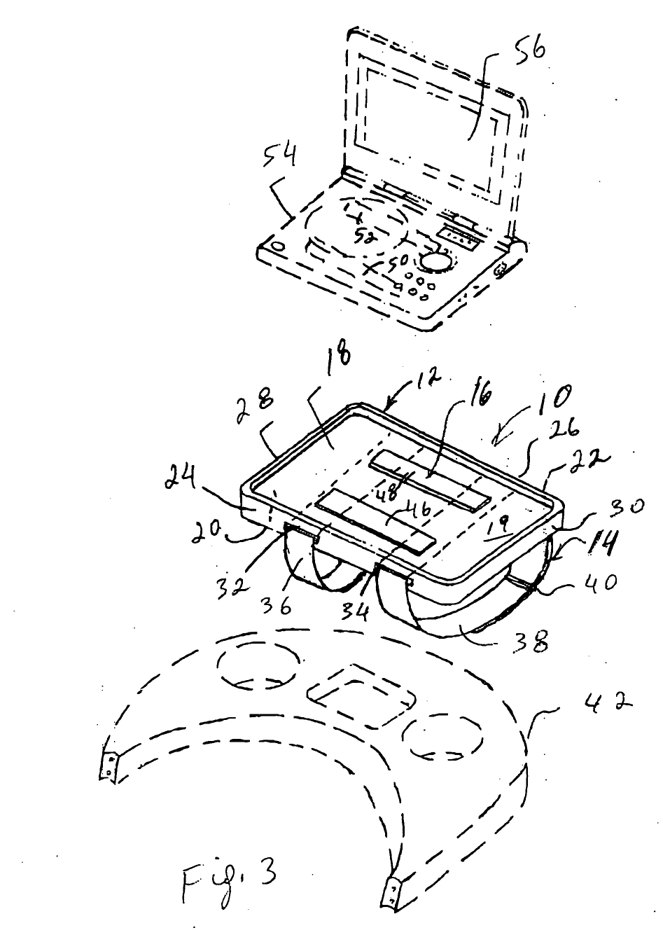

### DETAILED DESCRIPTION OF THE PREFERRED EMBODIMENT

Turning now to the drawings in more detail, numeral 10 designates the holder in accordance with the present invention. The holder 10 comprises a base 12, a means 14 for securing the base to a supporting structure and a means 16 for securing a portable electronic device to the base.

The base 12 comprises a substantially flat plate 18 having an upper surface 19 and a bottom surface 20. A transverse unitary flange 22 extends about the peripheral edges of the plate 18. The flange 22 has vertical dimensions greater than the thickness of the plate 18 such that an upper portion of the flange 22 extends above the upper surface 19 to form an upwardly extending lip. A lower portion of the flange 22 extends downwardly below the bottom surface 20 of the plate 18. The upwardly extending portion of the flange 22, which forms the peripheral lip prevents the electronic device positioned on the holder 10 from sliding from the upper surface 19.

The flange 22 has a first elongated side 24, a second elongated side 26, and first end 28, and a second end 30. A pair of elongated slots 32 and 34 is formed in the first elongated side 24 of the flange 22. A pair of opposing matching slots (not shown) is formed in the second elongated side 26 of the flange 22. The slots 32 and 34 extend at the vertical level below the bottom surface of the plate 18.

The securing means 16 comprises at least one flexible securing belt having sufficient length to extend below the bottom surface 20 and loop about a bottom surface of the supporting structure. In the preferred embodiment, two such belts are provided. A securing belt 36 extends through the slot 32 and through a corresponding slot in the second side 26. A securing belt 38 extends through the slot 34 and through a corresponding slot formed in the second side 26 of the flange 22. The belts 36 and 38 are each provided with a buckle 40, which allows tightening of the belts 36 and 38 on the supporting structure, such as for instance, a tray 42 of a stroller 44. The belts 36 and 38 extend across the bottom surface 20 of the plate 18 from the first side 24 to the second side 26.

The means 14 for securing the electronic device on the holder 10 comprises a pair of elongated strip fasteners 46 and 48 extending in a spaced-apart relationship to each other and in a generally parallel relationship to the sides 24 and 26 of the flange 22. The fasteners 46 and 48 can be made of hook-and-loop fastening material. A pair of matching fasteners 50, 52 is provided for securing on a bottom of an electronic device 54, for instance a portable DVD player. The tray 42 and the portable electronic device 54 do not form a part of the present invention. The fasteners 50 and 52 for attachment to the bottom of the electronic device 54 are provided together with the holder 10 to assure secure positioning of the electronic device 54 on the top surface 19 of the plate 18.

In operation, the user attaches fasteners 50 and 52 to the electronic device, be it a CD player, a DVD player, or any other entertaining or educational means selected by the user. The fasteners 50, 52, as well as the fasteners 46, 48 may attached by conventional means, for instance adhesive material. The holder 10 is then secured on the supporting tray 42, by releasing the buckles 40 and looping the securing belts 36 and 38 about the bottom of the tray 42. The belts are then tightened through the buckles 40, thereby detachably securing the holder 10 on the tray 42.

The user then positions the electronic device or other educational device within the area defined by the flange 22, aligning the fasteners 46, 48 with the fasteners 50, 52. A gentle downward pressure causes the hook-and-loop fasteners of the strips 46, 48, 50, and 52 to engage and secure position of the device 54 on the plate 18 of the holder 10. The tray 42 or any other supporting can then be secured on the stroller 44 such that a child positioned in the seat of the stroller 44 can view the screen 56 of the DVD player 54.

When not in use, the holder 10 can be easily released from its engagement with the tray 42 by releasing the belts 36 and 38 and lifting the holder 10 from the tray 42. The electronic device 54 can be removed prior to disengaging the holder 10 from the tray 42 by pulling the device 54 to release engagement of the hook-and-loop fasteners 46, 48, 50, and 52.

The holder 10 can be manufactured from a lightweight non-corrosive material, for instance lightweight sturdy plastic. The belts 36 and 38 can be made from flexible resilient or non-resilient material, depending on the manufacturer's preference. The strips 46 and 48 can be secured on the plate 18 by commercially available adhesive or attached to the upper surface 19 by the manufacturer of the holder 10.

It is envisioned that the holder 10 can be used with other supporting structures, for instance, laptop trays, breakfast trays, high chairs, safety brackets of a child's seat, and the like.

Many changes and modifications can be made in the design of the present invention without departing from the spirit thereof. We therefore, pray that our rights to the present invention be limited only by the scope of the appended claims.

We claim:

1. A holder for securing a portable electronic device on a panel, comprising:
a base having a top surface;
a means for detachably securing the base on the panel;
a means for detachably securing the portable electronic device on the base.

2. The holder of claim 1, wherein said base comprises a substantially flat plate and a peripheral flange extending about outer edges of the plate in a transverse relationship to the top surface.

3. The holder of claim 2, wherein said flange comprises an upper portion forming a peripheral lip extending about the base and a downwardly extending portion located below the top surface of the base.

4. The holder of claim 3, wherein said means for detachably securing the base comprises at least one flexible belt having longitudinal dimensions sufficient for extending under a bottom of the panel.

5. The holder of claim 4, wherein said downwardly extending portion is provided with at least a pair of opposing slots, and wherein said at least one belt is extendable through said at least pair of opposing slots.

6. The holder of claim 5, wherein said at least one belt is provided with a buckle to allow adjustable positioning of the base on the panel.

7. The holder of claim 1, wherein said means for detachably securing the portable electronic device comprises at least one hook-and loop fastener secured on the top surface of the base and a matching fastener securable on a bottom surface of the electronic device.

8. A holder for securing a portable DVD player on a tray of a stroller, the holder comprising:
a base having a top surface;
a transverse flange extending about the periphery of the base and forming an upwardly extending lip and a downwardly extending portion, said downwardly extending portion being provided with a plurality of spaced apart opposing slots;
a means for securing the base on the tray, said means comprising at least one flexible belt extending through opposing slots and adjustably extendable below a bottom of the tray; and
a means for detachably securing the DVD player on the top surface of the base.

9. The holder of claim 8, wherein said flexible belt carries a tightening buckle for adjustable securing of the belt about the bottom of said tray.

10. The holder of claim 8, wherein said means for detachably securing the DVD player on the top surface of the base comprises at least one fastener adapted for engagement with a matching fastener secured on a bottom of the DVD player.

11. The holder of claim 10, wherein said fastener comprises hook-and-loop members.

12. A method for releasably securing a portable DVD player on a tray, comprising the following steps:
providing a base plate having a downwardly extending transverse flange;
providing at least a pair of opposing slots formed in said downwardly extending transverse flange;
providing a flexible belt having longitudinal dimensions sufficient for extending below a bottom surface of the tray;
providing a first fastener secured to a top surface of the base and a matching second fastener securable on a bottom surface of the DVD player;
positioning the base on the tray and extending the flexible belt across the bottom surface of the tray;
positioning the DVD player on a top surface of the base, while aligning the first and the second fasteners.

13. The method of claim 12, wherein said flexible belt is provided with a tightening buckle, and wherein said method further comprises a step of adjusting the length of said belt using said buckle to secure the holder on said tray.

14. The method of claim 12, wherein said fasteners comprise strips of hook-and-loop fasteners.
